(19) United States
(12) Patent Application Publication
(10) Pub. No.: US 2024/0108000 A1
(43) Pub. Date: Apr. 4, 2024

(54) DISINFECTANT COMPOSITIONS EXHIBITING ENHANCED BIOCIDAL BENEFITS

(71) Applicant: Pilot Chemical Corp., West Chester, OH (US)

(72) Inventors: Edward Fu, Cranberry Township, PA (US); Heather Frank, Pittsburgh, PA (US); Yuanxi Liao, Pittsburgh, PA (US); Liang Huang, Pittsburgh, PA (US); Colin Paul Horwitz, Pittsburgh, PA (US); James W. Ogle, Pittsburgh, PA (US)

(21) Appl. No.: 18/478,097

(22) Filed: Sep. 29, 2023

Related U.S. Application Data
(60) Provisional application No. 63/479,006, filed on Jan. 9, 2023.
(60) Provisional application No. 63/378,105, filed on Oct. 3, 2022.

(51) Int. Cl. A01N 33/12; A01N 25/04; A01N 25/06; A01N 25/30; A01P 1/00

(52) U.S. Cl. CPC A01N 33/12; A01N 25/04; A01N 25/06; A01N 25/30; A01P 1/00

(57) ABSTRACT

Disinfectant compositions are disclosed which provide a durable residual antimicrobial benefit to surfaces treated with such compositions. The disinfectant compositions include a biocidal agent, an amphoteric copolymer, and other functional agents. Methods of making and using the disinfectant compositions are further provided.

### CROSS-REFERENCE TO RELATED APPLICATIONS

The present application claims the priority benefit of U.S. Provisional Patent App. Ser. No. 63/378,105, filed Oct. 3, 2022, and of U.S. Provisional Patent App. Ser. No. 63/479,006, filed Jan. 9, 2023, each of which is hereby incorporated herein by reference.

### TECHNICAL FIELD

The present disclosure generally relates to disinfectant compositions which exhibit enhanced biocidal benefits.

### BACKGROUND

Compositions useful to clean and disinfect surfaces are critical for hygiene, health, and public safety. Typically, such compositions include surfactants and biocidal agents to remove soil and destroy microorganisms such as bacteria and viruses to render them non-infectious. The cleaning and disinfecting benefits of conventional disinfectant compositions are immediate and not durable with microbes able to recolonize and grow on the treated surfaces.

### SUMMARY

According to one embodiment, a disinfectant composition includes a quaternary ammonium biocidal agent, an amphoteric copolymer; and a functional agent comprising one or more of a surfactant, a wetting agent, and an emulsifier.

According to another embodiment, a method of providing a residual cleaning benefit to a surface includes applying a disinfectant composition to the surface and allowing the disinfectant composition to dry and leave a residual film on the surface. The residual film provides the residual cleaning benefit. The disinfectant composition includes a quaternary ammonium biocidal agent, an amphoteric copolymer; and a functional agent comprising one or more of a surfactant, a wetting agent, and an emulsifier.

### BRIEF DESCRIPTION OF THE DRAWINGS

FIG. 1 depicts a photograph of a Gardener Scrub Abrasion Tester used for wear and re-inoculation tests.

FIG. 2 depicts a chart illustrating the greasy soil cleaning performance on vinyl tile of the evaluated disinfectant compositions.

FIG. 3 depicts a chart illustrating the greasy soil cleaning performance on wallboard of the evaluated disinfectant compositions.

### DETAILED DESCRIPTION

The present application describes novel disinfectant compositions which can immediately clean and disinfect surfaces and then subsequently continue to provide a durable biocidal benefit to the treated surfaces. As prescribed by the EPA 01-1A Protocol, the novel compositions provide residual sanitization of treated surfaces for up to 24 hours. The durable biocidal benefit can decrease the incidence of bacteria transmission as a vector for disease infection by reducing, or substantially eliminating, the presence and/or viability of infectious bacteria on publicly touched surfaces. As can be appreciated, there is a critical need to provide safe and sanitary surfaces in public spaces and other shared spaces such as hospitals and corporate offices in the duration of time between regular cleanings.

Generally, the disinfectant compositions described herein can include a combination of biocidal agents, amphoteric copolymers, and other functional agents dissolved in a carrier solvent. Without being bound by theory, it is believed that the residual antimicrobial benefits provided by the disinfectant compositions are caused by the formation of a residual film on a desired surface after the composition is applied and after drying or evaporation of the carrier solvent. The residual film can continue to provide biocidal benefits due to continued activity of the biocidal agents as facilitated by the film-forming agent(s). It is specifically believed that amphoteric copolymers can assist in maintaining activity of the biocidal agents.

The residual antimicrobial benefit provided by the disinfectant compositions described herein can be long-lasting and durable for up to 24 hours. For the duration of the residual antimicrobial benefit period, bacteria are significantly reduced in population to a substantially safer level by the continued activity of the biocidal agents. Generally, the residual sanitizing benefit can withstand minor abrasion and wear without being disturbed including, for example, touching of the surface and exposure to dry atmosphere and light.

In certain embodiments, the described disinfectant composition can be a liquid composition. The disinfectant composition can be applied and used similarly to other known liquid disinfectant compositions. Drying of the disinfectant composition can form a residual film on the treated surface that can exhibit the residual antimicrobial property.

Biocidal Agents

The disinfectant compositions described herein can exhibit residual sanitizing benefits through the inclusion of quaternary ammonium biocidal agents. In certain embodiments, suitable quaternized ammonium compounds can be formed by reacting dialkyl methyl amine or alkyl benzyl methyl amine with methyl chloride to form dialkyl dimethyl ammonium chloride or alkyl benzyl dimethyl ammonium chloride, respectively. Generally, any known quaternary ammonium compounds can be suitable particularly U.S. Environmental Protection Agency (“EPA”) registered quaternary ammonium compounds.

In certain embodiments, the biocidal agents can be commercially obtained. For example, Maquat® MQ624M marketed by the Pilot Chemical Co. (Cincinnati, OH), can be a suitable biocidal agent. Maquat® MQ624M is an 80% active 40% n-alkyl (50% C15, 40% C12, 10% C16) dimethylbenzyl ammonium chloride and 60% dioctyl, dodecyl, octyldecyl dimethyl ammonium chloride. Maquat® MQ624M is an EPA registered biocide. Other Maquat® biocides including Maquat® 4480, Maquat LC12S, and Maquat® 1412 can also be suitable biocidal agents. Maquat 4480 is didecyl dimethyl ammonium chloride (“DDAC”) and is a registered biocide. Maquat LC12S is alkyl dimethyl benzyl ammonium chloride where the alkyl group is majority linear C₁₂ chain length with less C₁₄ (67% C12, 25% C14, 7% C16, 1% C18). Maquat® LC12S is a registered biocide. Maquat® 1412 is alkyl dimethyl benzyl ammonium chloride where the alkyl group is majority linear C₁₄ chain length with less C₁₂ (50% C14, 40% C12, 10% C16). Maquat® 1412 is a registered biocide.

Generally, the biocidal agent can be included in certain embodiments of the disinfectant composition at about 0.01% to about 5%, by weight, including for example in certain embodiments from at about 0.2% to about 0.8%, by weight. In certain embodiments, the biocidal agent can be Maquat® MQ624M and can be included at about 0.5%, by weight.

Amphoteric Copolymer

Generally, suitable amphoteric polymers for the disinfectant compositions disclosed herein can be copolymers formed from at least one cationic monomer and at least one anionic monomer. In certain embodiments, the amphoteric copolymer can also be substantially, or entirely, cationic through alternative formation with non-ionic monomers instead of anionic monomers.

Suitable amphoteric polymers can, in combination with other film-forming agents, form a stable residual film on a surface treated with the disinfectant composition. The cationic and anionic functionality can both stabilize the biocidal agents and allow them to remain active on the treated surface and, depending on the monomers, provide additional biocidal activity.

Suitable cationic monomers for the amphoteric copolymer can vary widely and can include, for example, olefinic unsaturated compounds having straight or branched C1-C30 alkyls, substituted aryls, radicals, poly oxyalkene condensates of an aliphatic radical, quaternized acrylic acid ester derivatives or acrylamide quaternized derivatives; and heteroatomic alkyl or aromatic radicals containing one or more quaternized nitrogen atoms or one or more amine groups.

Specific examples of suitable cationic monomers can include co-poly 2-vinyl pyridine, co-poly 2-vinyl N-alkyl quaternary pyridinium salts, co-poly 4-vinyl pyridine, co-poly 4-vinyl N-alkyl quaternary pyridinium salt, co-poly 4-vinylbenzyltrialkylammonium salts, co-poly 4-vinylbenzyltrimethylammonium salt, co-poly 2-vinyl piperidine, co-poly 2-vinyl piperidinium salt, co-poly 4-vinyl piperidine, co-poly 4-vinyl piperidinium salt, co-poly 3-alkyl 1-vinyl imidazolium salts, co-poly 3-methyl 1-vinyl imidazolium salt, acrylamides, methacrylamidos, co-poly dimethyl aminopropylmethacrylamide, co-poly acrylamidopropyl trimethylammonium salt, co-poly methacrylamidopropyl trimethylammonium salt, acrylates, methacrylates, co-poly dimethyl aminoethyl (meth)acrylate, co-poly ethanaminium N,N,N trimethyl 2-[(1-oxo-2 propenyl)oxy]-salt, co-poly ethanaminium N,N,N trimethyl 2-[(2 methyl-1-oxo-2 propenyl) oxy]-salt, co-poly ethanaminium N,N,N ethyl dimethyl 2-[(2 methyl-1-oxo-2 propenyl) oxy]-salt, co-poly vinyl amines, co-polyvinylammonium salt, co-poly diallylamine, co-poly methyldiallylamine, co-poly diallydimethylammonium salt, imine cationic monomers, cocodimethylammonium hydroxypropyl oxyethyl cellulose, lauryidimethylammonium hydroxypropyl oxyethyl cellulose, stearyldimethylammonium hydroxypropyl oxyethyl cellulose, and stearyldimethylammonium hydroxyethyl cellulose; guar 2-hydroxy-3-(trimethylammonium)propyl ether salt; cellulose 2 -hydroxyethyl 2-hydroxy 3-(trimethyl ammonio) propyl ether salt, sulfonium salts, and derivatives thereof. Suitable counterions can include halides, hydroxides, phosphate, sulfate, hydrosulfate, ethyl sulfate, methyl sulfate, formate, and acetate.

Alternatively, or additionally, suitable monomers can be amphoteric monomers. Examples of such monomers can include N,N-dimethyl, N-acetyl aminoethyl(meth)acrylate, vinyl pyrrolidone, vinyl oxazolidone, vinyl methyoxazolidone, and vinyl caprolactam.

The weight percentage of the cationic or amphoteric monomer can vary from about 1% to about 100%, in certain embodiments, from about 10% to about 100%, in certain embodiments, and from about 15% to about 80%, in certain embodiments, of the entire amphoteric copolymer. The remaining monomers used to form the amphoteric copolymer can be anionic monomers and/or non-ionic monomers.

Suitable anionic monomers can include α-ethacrylic acid, α-cyano acrylic acid, f3,f3-dimethacrylic acid, methylenemalonic acid, vinylacetic acid, allylacetic acid, acrylic acid, ethylidineacetic acid, propylidineacetic acid, crotonic acid, methacrylic acid, maleic acid, fumaric acid, itaconic acid, sorbic acid, angelic acid, cinnamic acid, β-styryl acrylic acid (1-carboxy-4-phenyl butadiene-1,3), citraconic acid, glutaconic acid, aconitic acid, α-phenylacrylic acid, β-acryloxy propionic acid, citraconic acid, vinyl benzoic acid, N-vinyl succinamidic acid,mesaconic acid, co-poly styrene sulfonic acid, 2-methacryloyloxymethane-1-sulfonic acid, 3-methacryloyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid and vinyl phosphoric acid; and the anionic sodium or potassium salts of each of these monomers.

Suitable non-ionic monomers can include vinyl alcohol; vinyl acetate; vinyl methyl ether; vinyl ethyl ether; acrylamide, methacrylamide and other modified acrylamides; vinyl propionate; alkyl acrylates (esters of acrylic or methacrylic acid); hydroxyalkyl acrylate esters; co -poly ethylene oxide, co-poly propylene oxide, and co-poly oxymethylene, and hydroxyethylcellulose derivatives.

The average molecular weight of suitable amphoteric copolymers can range from about 1000 to about 10⁷ daltons.

Suitable amphoteric copolymers can be commercially obtained. For example, suitable amphoteric polymers can include Floc Aid polymers marketed by Nouryon Co. (Amsterdam, NL), Salcare polymers marketed by Allied Colloids Inc. (Bradford District, UK), Luviquat FC and HM polymers marketed by BASF SE (Ludwigshafen, DE), Merquat polymers marketed by Calgon Corp. (Pittsburgh, PA), and Sandolee polymers marketed by Clamant AG (Muttenz, CH).

A particularly suitable amphoteric copolymer is Floc Aid 19 (Nouryon Co. (Amsterdam, NL)) in certain embodiments. Floc Aid 19 includes 34%, by weight, acrylic acid; 51%, by weight, diallyl dimethyl ammonium chloride; and 15%, by weight, 2-hydroxylpropyl acrylate. Floc Aid 19 has a molecular weight of 1.4*10⁵ daltons and is provided at a 27.5% active composition in water.

The disinfectant compositions described herein can include the amphoteric copolymer at about 0.01% to about 0.6%, by weight. For example, in embodiments including Floc Aid 19, Floc Aid 19 can be included at about 0.05% to about 0.5%, by weight, at its 27.5% active formulation. In certain embodiments, Floc Aid 19 can be included at about 0.1%, by weight.

Functional Agents

The disinfectant compositions described herein includes functional agents to both stabilize the amphoteric polymer and to provide additional cleaning benefits. Examples of suitable functional agents include surfactants, co-surfactants, wetting agents, emulsifiers, and stabilizing agents. As can be appreciated, certain functional agents can provide multiple benefits. For example, certain compounds can serve as a wetting agent, a surfactant, and/or as an emulsifier.

In general, surfactants can provide multiple benefits to the disinfectant compositions described herein including soil removal benefits and improved dispersibility benefits. For example, surfactants can lower the surface tension of the carrier solvent to enable soil removal, faster dispersion across the surface to be clean, and can aid in the destruction of lipid bilayers that form outer structures of infectious agents.

Although any suitable surfactants can be used, particularly useful surfactants can include hydrophilic non-ionic surfactants and amphoteric surfactants. Among such surfactants, those having a relatively higher hydrophilic-lipophilic balance (“HLB”) can be particularly suitable in certain embodiments. In certain embodiments, a hydrophilic surfactant (non-ionic or amphoteric) can have a HLB of 10 or more; and in certain embodiments, 15 or more. Examples of suitable hydrophilic surfactants (non-ionic or amphoteric) can include ethoxylated alcohols and alkylphenols, fatty acid esters, polysorbates (such as Tween 40 or Tween 20), nitrogenated non-ionic surfactants, and alkylpolyglucosides.

Suitable non-ionic surfactants can be commercially obtained. For example, Masopon® surfactants from the Pilot Chemical Co. (Cincinnati, OH) can be used. A specific example of a suitable surfactant is Masopon® 425N which is a naturally derived C8-C16 alkyl polyglucoside surfactant which exhibits good wetting, dispersing, and foaming. Masopon® 425N is provided as a 50% active solution.

In certain embodiments, a co-surfactant can be included as a functional agent. Co-surfactants can act as an additional surfactant while also providing additional benefits such as increased wetting. Particularly suitable co-surfactants can include zwitterionic and/or amphoteric co-surfactants such as hydroxy-sultaine-type surfactants, betaine-type surfactants, and amine oxide-type surfactants.

Co-surfactants, when included, can be commercially obtained. For example, suitable co-surfactants include Macat® and Caltaine® type amphoteric and zwitterionic surfactants marketed by the Pilot Chemical Co. (Cincinnati, OH). Macat® type surfactants include laureth carboxylic acid, lauryl dimethylamine oxide, decyl dimethylamine oxide, alkyl dimethylamine oxide, behenamidopropyl dimethylamine, cocamidopropyl hydroxysultaine, cetyl betaine, dioctyl sodium sulfosuccinate, lauryl betaine, lauryl cetyl betaine, capryl/capramidopropyldimethyl betaine, lauryl hydroxysultaine, myristyl/cetyl dimethylamine oxide, myristyl/cetyl dimethylamine oxide, tallow dihydroxyethyl betaine, cocamidopropylamine oxide, cocamidopropyl betaine, lauramidopropylamine oxide. Caltaine® type surfactants include cocamidopropyl betaine, lauramidopropyl betaine, dodecanamidopropyl betaine, and lauroylamide propylbetaine.

In certain embodiments, a suitable co-surfactant can be Macat® AO-12. Macat® AO-12 is 30% active lauryl (C12) dimethylamine oxide in water. In addition to acting as a co-surfactant, Macat® AO-12 exhibits excellent wetting, cleaning, and foam boosting properties.

pH modifiers can be included in certain embodiments. For example, an amino alcohol can be included in certain embodiments to provide stabilization and emulsification benefits. Amino alcohols are generally formed by reacting a secondary amine with an epoxide such as a diepoxide or triepoxide. Examples of suitable stabilizers can include monoisopropanolamine (sometimes referred to as “MIPA”) and monoethanolamine. In certain embodiments, monoisopropanolamine can be used as a pH modifier.

In certain embodiments, a chelating agent can be included to improve the ability of the disinfectant composition to clean surfaces contaminated with dissolved minerals such as calcium. Generally, any known chelating agent such as ethylenediaminetetraacetic acid (“EDTA”) can be used including various salts thereof.

As can be appreciated, other functional agents can be included such as foaming agents, antifoaming agents, pH buffering agents, viscosity modifiers, and UV inhibitors.

In certain embodiments, each of the functional agents can be included at about 0.05% to about 5%, by weight, of the overall residual cleaning compositions described herein or in certain embodiments at about 0.2% to about 2%.

In certain embodiments, the functional agents can include a non-ionic surfactant, an amphoteric co-surfactant, a stabilizer, and a chelating agent. In certain embodiments, the non-ionic surfactant can be an alkylpolyglucoside, the amphoteric co-surfactant can be an amine-oxide surfactant, the pH modifier can be an amino alcohol, and the chelating agent can be EDTA or disodium EDTA.

In certain embodiments, the disinfectant composition can include Masopon® 425N C8-C16 alkyl polyglucoside as a surfactant, Macat® AO-12 30% active lauryl (C12) dimethylamine oxide as a co-surfactant, monoisopropanolamine as a stabilizer, and disodium EDTA as a chelating agent. In certain such embodiments, the Masopon® 425N can be included at about 0.4% by weight; Macat® AO-12 at about 0.8%, by weight; monoisopropanolamine at about 0.6% by weight; and di sodium EDTA at about 1.0%, by weight.

Carrier Solvent

Generally, each of the components of the disinfectant compositions described herein can be dissolved, or dispersed, within a suitable carrier solvent that is compatible with each of the other components. As can be appreciated, a suitable carrier solvent can be water in certain embodiments. Water has many advantages including high compatibility with other components and excellent safety.

In certain alternative embodiments, an organic solvent, such as a C1 to C8 alcohol, an alkylene glycol ether, or a terpene can alternatively be used as the carrier solvent. Such solvents can be water soluble, partially water soluble, or water miscible. Organic solvents can be useful to enable faster drying of the disinfectant composition or to provide an immediate biocidal effect.

The disinfectant compositions can be provided as a concentrated liquid or as a diluted liquid. In concentrated liquid embodiments, a user can dilute the composition with a solvent (e.g., water). In certain embodiments, the amount of dilution can be about one part of the concentrated liquid composition to about 1 part to about 10 parts of the solvent. In certain embodiments, the amount of dilution can be about one part of the concentrated liquid composition to about 4 to about 8 parts of the solvent.

As can be appreciated, the disinfectant composition can be further modified and used as known in the art. For example, a pressurized aerosol system can be formed by addition of a suitable propellant to the disinfectant composition described herein. Additionally, or alternatively, colorants, scents, pH modifiers, corrosion inhibitors, coupling agents, rheology modifiers, UV stabilizers, preservatives, optical brighteners, etc. can be included as known in the art.

The disinfectant compositions can be used similarly to conventional cleaning products. For example, the disinfectant composition can be applied to a desired surface to be treated by way of an applicator, such as a conventional spray bottle or wipe, and then the surface can be cleaned and allowed to dry actively (through use of mechanical action) or dry passively (through ambient environment). Generally, any surface cleanable with a liquid composition can be cleaned with the disinfectant compositions described herein. For example, table surfaces, countertops, faucets, shelves, windows, glass or Plexiglas dividers, chairs, handrails, door handles, elevator buttons, and electronic equipment can all be cleaned with the disinfectant compositions.

### EXAMPLES

Residual Sanitization Tests

Residual sanitization tests were performed using the EPA 01-1A Protocol for Residual Self-Sanitizing Activity of Dried Chemical Residues on Hard, Non-Porous Surfaces with some minor revisions. The following provides a summary of the method.

Bacteria Preparation

A colony of test bacteria, either Klebsiella pneumoniae (ATCC 4352) or Staph aureus (ATCC 6538) was inoculated in nutrient broth and underwent two consecutive daily transfers to fresh nutrient broth prior to use. This bacteria suspension is then inoculated on test carriers, one-inch squares made of minor-finish stainless steel.

Test Surface Preparation

Four inoculated squares were placed in a single 15x100 mm petri dish and sprayed three times with the test solution to thoroughly wet the surface. Four other inoculated squares, serving as controls, were treated with 0.01 vol. % Triton X-100 in the same manner. Each square was individually transferred to a fresh petri dish and dried overnight with the lids ajar at room temperature and 45-55% relative humidity.

Wear and Re-inoculation Tests

After overnight drying of the sprayed carriers, the test squares were subjected to 12 wear cycles in parallel to the control squares. A Gardener Scrub Abrasion Tester was fitted with the friction boat attachment and added weights as specified in the EPA 01-1A Protocol. Foam pad and cotton wiping cloth were cut to cover the abrasion plate surface. One cycle consisted of a single pass of the abrasion boat to the right and a return pass to the left. Four squares were tested at a time in the configuration depicted in FIG. 1.

The 12 wear cycles consisted of alternating dry and wet cycles, starting with a dry wipe. For wet cycles, the wiping cloth attached to the abrasion boat was sprayed at a distance of 75 cm with deionized water for about 1 second using a Preval aerosol sprayer. A bacteria re-inoculation was performed using a plastic disposable inoculating loop after each of the first five cycles using the 24-hour re-inoculation culture. Wait times were carried out as indicated in the protocol (15 minutes after each wear cycle and 30 minutes after each bacteria re-inoculation). All bacteria re-inoculations were completed on the first day. Wear cycles were done on two consecutive days, in-between which the squares were stored overnight in petri dishes with closed lids at 45-55% RH.

Sanitizer Test

After completion of wear cycles on the second day of testing, the sanitizer test was carried out immediately (>24 hours after product application). 10 mL of the final test culture was spread onto each square using a plastic disposable inoculating loop. The squares were transferred into individual 250-mL polypropylene tubes containing 30 mL of neutralizer (letheen broth) after a 5-minute contact time. The bottles were then sonicated for 20 s and finally placed in a shaking incubator set to 250 rpm for 3-4 minutes.

The neutralizer solution in each polypropylene bottle was serially diluted and spread plated. The spread plates were stored in a 37 C incubator for 48 hours, after which time bacterial growth was quantified and the reduction of bacteria on the test squares in comparison to the control squares was calculated. The passing criterion for a sanitizer is a minimum of 3 log reduction.

Cleaning Tests

ASTM D4488-95 describes test procedures for evaluating cleaning products for floors and walls. The Gardner Scrub Abrasion Tester was configured with three sponge attachments to run cleaning tests in triplicate. Painted wallboard, as described in ASTM D4488-95, and white vinyl tile were used as test substrates. A greasy soil from method A6 in ASTM D4488-95, was applied by paintbrush to clean substrates. The soil was composed of 63.7% paint thinner, 5.1% vegetable oil, 12.7% mineral oil, 12.7% clay, and 5.7% graphite powder. 20 gm of test solution was pipetted to each sponge, and the soil substrate was scrubbed for a set number of cycles. Percent soil removed was calculated for each test by digital analysis of images taken of unsoiled, soiled, and cleaned tiles.

### Examples

Residual Sanitization

Table 1 summarizes a range of Example compositions to evaluate residual sanitization properties. In Table 1, concentrations of each of the Example compositions components are expressed in weight percent of the active functional ingredients. The remainder of each example is water.

TABLE 1

| Com- | Ex. | Ex. | Ex. | Ex. | Ex. | Ex. | Ex. | Ex. | Ex. | Ex. | Ex. |
|---|---|---|---|---|---|---|---|---|---|---|---|
| ponent | 1 | 2 | 3 | 4 | 5 | 6 | 7 | 8 | 9 | 10 | 11 |
| Ma- | 0.8 | 0.8 | 0.6 | 0.7 | 0.4 | 0.5 | 0.45 | 0.2 | 0.32 | 0.32 | 0.32 |
| quat ® | | | | | | | | | | | |
| MQ624M | | | | | | | | | | | |
| Floc Aid | 0.13 | 0.1 | 0.1 | 0.1 | 0.1 | 0.1 | 0.1 | 0.1 | 0.1 | — | 0.05 |
| 19 | | | | | | | | | | | |
| Macat ® | 0.8 | 0.8 | 0.8 | 0.8 | 0.8 | 0.8 | 0.8 | 0.8 | 0.8 | 0.8 | 0.8 |
| AO-12 | | | | | | | | | | | |
| Masopon | 0.4 | 0.4 | 0.4 | 0.4 | 0.4 | 0.4 | 0.4 | 0.4 | 0.4 | 0.4 | 0.4 |
| 425N | | | | | | | | | | | |
| MIPA | 0.6 | 0.6 | 0.6 | 0.6 | 0.6 | 0.6 | 0.6 | 0.6 | 0.6 | 0.6 | 0.6 |
| EDTA- | 0.7 | 1.0 | 1.0 | 1.0 | 1.0 | 1.0 | 1.0 | 1.0 | 1.0 | 1.0 | 1.0 |
| 2Na | | | | | | | | | | | |

Table 2 depicts the EPA 01-1A residual sanitization results for the Example compositions of Table 1 as determined by internal testing. Example 9 was further tested by an external laboratory and had results consistent with the internal testing.

TABLE 2

| Log | | | | | | | | | | | |
|---|---|---|---|---|---|---|---|---|---|---|---|
| Re- | Ex. | Ex. | Ex. | Ex. | | Ex. | Ex. | Ex. | Ex. | Ex. | Ex. |
| duction | 1 | 2 | 3 | 4 | Ex. 5 | 6 | 7 | 8 | 9 | 10 | 11 |
| K. | 4.0 | 4.0 | 4.6 | 4.6 | 3.7/4.7 | 4.0 | 4.5/ | 4.5 | >4.5 | 0.2 | 0.6 |
| pneu- | | | | | (4.9 | | 4.8 | | | | |
| moniae | | | | | after 3 | | | | | | |
| | | | | | months | | | | | | |
| | | | | | at | | | | | | |
| | | | | | 54° C.) | | | | | | |
| S. aureus | — | — | — | — | 5.0 | — | 5.0 | — | >4.2 | — | — |

Each Example composition is a clear, homogeneous solution that meets the efficacy criteria for 24-hour residual sanitization, except for Example compositions 10 and 11, which have lower levels of Floc Aid 19 amphoteric polymer. Example compositions 5, 8 and 9 were tested against both K. pneumoniae and S. aureus and are considered inventive because each met the criterion of >3 log reduction against the organisms. The stability of Example composition 5 was tested by storing in an oven set at 54° C. for an extended period (3 months). After three months under these conditions, the formula remained clear and homogeneous. It was then tested against K. pneumoniae and passed with over 4 log reduction. This indicates that the Example compositions have excellent physical chemical stability.

Examples 10 and 11 failed to exhibit a residual sanitization effect as each exhibited less than a 3-log reduction. Specifically, Example 10 without Floc Aid 19, exhibited only a 0.2 log reduction while Example composition 11, with 0.05% Floc Acid 19, exhibited only a 0.6 log reduction. The remaining Example compositions, including at least 0.1% Floc Aid 19 each exhibited a log reduction of 4 or greater. These results suggest that there is a minimal level of the amphoteric polymer needed to achieve the necessary 3 log reduction for residual sanitization. This clearly shows the effectiveness of the amphoteric polymer in retaining formula ingredients on surfaces so that a residual effect on sanitization efficacy can be attained. It should be expected that the minimal level of amphoteric polymer needed for residual sanitization will vary according to the disinfectant composition, and specifically, the level of active ingredient in the composition.

Cleaning Tests

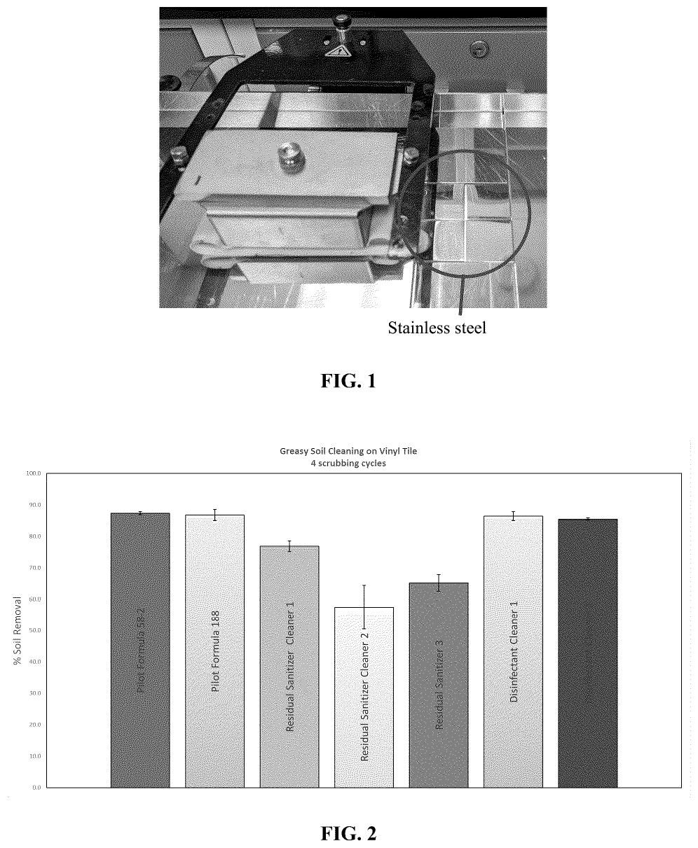

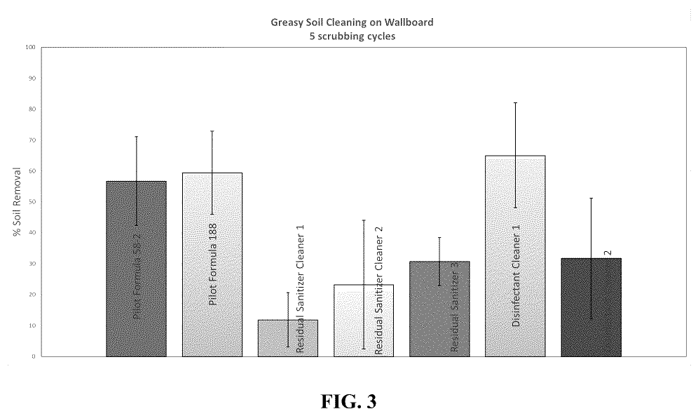

In addition to residual sanitization properties, the Example compositions also perform well as hard surface cleaners. As can be appreciated, products that sanitize and disinfect hard surfaces are commonly used to clean them as well. Example compositions 6 and 9 were compared against 3 commercially available residual sanitizer cleaners and 2 commercially available disinfectant cleaners for soil removal in accordance to ASTM D4488-95. The results are depicted in FIGS. 2 and 3 wherein Example composition 6 is listed as “Pilot Formulation 58-2” and Example 9 is listed as “Pilot Formulation 188.”

FIG. 2 compares cleaning performance on greasy soil from vinyl tile. As the surface is relatively smooth, higher soil removal levels are possible with effective cleaners. The Example compositions exhibit better cleaning performance compared to other residual sanitizers, and on par with leading disinfectant cleaners. A similar trend is apparent in the results from FIG. 3 which evaluates cleaning performance on wallboard substrate. The wallboard substrate is more textured and absorbent, making the surface more difficult to clean. Higher soil removal levels can be achieved with additional scrubbing cycles in the test method. Both Example compositions have similar cleaning performance, and are more effective in cleaning than other residual sanitizers.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. Certain embodiments disclosed herein can be combined with other embodiments as would be understood by one skilled in the art. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A disinfectant composition comprising:
a quaternary ammonium biocidal agent;
an amphoteric copolymer; and
a functional agent comprising one or more of a surfactant, a wetting agent, and an emulsifier.

2. The disinfectant composition of claim 1, wherein the quaternary ammonium biocidal agent comprises one or more of dialkyl dimethyl ammonium chloride and alkyl benzyl dimethyl ammonium chloride.

3. The disinfectant composition of claim 1, wherein the quaternary ammonium biocidal agent comprises about 40% n-alkyl (50% C15, 40% C12, 10% C16) dimethylbenzyl ammonium chloride and about 60% dioctyl, dodecyl, octyldecyl dimethyl ammonium chloride.

4. The disinfectant composition of claim 1, wherein the amphoteric copolymer is formed from one or more cationic or amphoteric monomers and one or more anionic or non-ionic monomers; and
wherein the one or more cationic or amphoteric monomers comprise olefinic unsaturated compounds having straight or branched C1-C30 alkyls, substituted aryls, radicals, poly oxyalkene condensates of an aliphatic radical, quaternized acrylic acid ester derivatives or acrylamide quaternized derivatives; heteroatomic alkyl or aromatic radicals containing one or more quaternized nitrogen atoms or one or more amine groups; N,N-dimethyl; N-acetyl aminoethyl(meth)acrylate; vinyl pyrrolidone; vinyl oxazolidone; vinyl methyoxazolidone; and vinyl caprolactam; and
the one or more anionic or non-ionic monomers comprise α-ethacrylic acid, α-cyano acrylic acid, β,β-dimethacrylic acid, methylenemalonic acid, vinylacetic acid, allylacetic acid, acrylic acid, ethylidineacetic acid, propylidineacetic acid, crotonic acid, methacrylic acid, maleic acid, fumaric acid, itaconic acid, sorbic acid, angelic acid, cinnamic acid, β-styryl acrylic acid (1-carboxy-4-phenyl butadiene-1,3), citraconic acid, glutaconic acid, aconitic acid, α-phenylacrylic acid, β-acryloxy propionic acid, citraconic acid, vinyl benzoic acid, N-vinyl succinamidic acid,mesaconic acid, co-poly styrene sulfonic acid, 2-methacryloyloxymethane-1-sulfonic acid, 3-methacryloyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl alcohol; vinyl acetate; vinyl methyl ether; vinyl ethyl ether; acrylamide, methacrylamide and other modified acrylamides; vinyl propionate; alkyl acrylates (esters of acrylic or methacrylic acid); hydroxyalkyl acrylate esters; co-poly ethylene oxide, co-poly propylene oxide, co-poly oxymethylene, hydroxyethylcellulose derivatives, and sodium or potassium salts thereof.

5. The disinfectant composition of claim 4, wherein the amphoteric copolymer comprises about 15% to about 80%, by weight, of the one or more cationic or amphoteric monomers.

6. The disinfectant composition of claim 4, wherein the average molecular weight of the amphoteric copolymer is about 1000 daltons to about 10⁷ daltons.

7. The disinfectant composition of claim 4, wherein the amphoteric copolymer comprises about 34%, by weight, acrylic acid; about 51%, by weight, diallyl dimethyl ammonium chloride; and about 15%, by weight, 2-hydroxylpropyl acrylate.

8. The disinfectant composition of claim 7, wherein the amphoteric copolymer has a molecular weight of about 1.4*10⁵ daltons.

9. The disinfectant composition of claim 1, wherein the functional agent comprises one or more of a hydrophilic non-ionic surfactant and an amphoteric surfactant.

10. The disinfectant composition of claim 1, wherein the surfactant of the functional agent exhibits a hydrophilic-lipophilic balance (“HLB”) or about 10 or more.

11. The disinfectant composition of claim 1, wherein the surfactant of the functional agent comprises a C8-C16 alkyl polyglucoside.

12. The disinfectant composition of claim 1, wherein the functional agent further comprises an amine-oxide co-surfactant.

13. The disinfectant composition of claim 1, wherein the functional agent further comprises an amino alcohol stabilizer.

14. The disinfectant composition of claim 1, wherein the functional agent further comprises a chelating agent, the chelating agent comprising one or more of ethylenediaminetetraacetic acid (“EDTA”) and disodium EDTA.

15. The disinfectant composition of claim 1, wherein the functional agent comprises a surfactant, a co-surfactant, a stabilizer, and a chelating agent.

16. The disinfectant composition of claim 1 further comprises a carrier solvent, and wherein the carrier solvent comprises water.

17. The disinfectant composition of claim 1 comprises:
about 0.01% to about 5%, by weight, of the biocidal agent;
about 0.01% to about 0.6%, by weight, of the amphoteric copolymer;
about 0.05% to about 5%, by weight, of each component the functional agents.

18. The disinfectant composition of claim 1 is an aqueous spray or a pressurized aerosol system.

19. The disinfectant composition of claim 1 provides a residual cleaning benefit to cleaned surfaces for about 24 hours or greater when measured in accordance to U.S. Environmental Protection Agency (“EPA”) 01-1A standards.

20. A method of providing a residual cleaning benefit to a surface comprising:
applying a disinfectant composition to the surface; and
allowing the disinfectant composition to dry and leave a residual film on the surface; and
wherein the residual film provides the residual cleaning benefit; and
wherein the disinfectant composition comprises:
a quaternary ammonium biocidal agent;
an amphoteric copolymer; and
a functional agent comprising one or more of a surfactant, a wetting agent, and an emulsifier.
